(19) United States
(12) Patent Application Publication
(10) Pub. No.: US 2025/0009183 A1
(43) Pub. Date: Jan. 9, 2025

(54) STAND-ALONE APPLIANCE FOR A COOKING HOB COMPRISING A HANDLE, AND METHOD FOR OPERATING A STAND-ALONE APPLIANCE

(71) Applicant: Miele & Cie. KG, Guetersloh (DE)

(72) Inventor: Andreas ENSLIN, Guetersloh (DE)

(21) Appl. No.: 18/711,623

(22) PCT Filed: Nov. 9, 2022
(86) PCT No.: PCT/EP2022/081305

§ 371 Date: May 20, 2024

(30) Foreign Application Priority Data
Nov. 30, 2021 (DE) 10 2021 131 336.8

(51) Int. Cl. A47J 45/06; A47J 36/32

(52) U.S. Cl. CPC A47J 45/068; A47J 36/321

(57) ABSTRACT

A placeable cooktop utensil includes: at least one handle having a gripping portion with at least one gripping region that is integrated in the handle so as to allow a user to grip the placeable utensil with a hand; a controller; and a transmitting unit connected in signal communication with the controller so as to transmit signals from the placeable utensil to the cooktop. The at least one gripping region has at least one touch sensor connected in signal communication with the controller so as to detect when the at least one handle is gripped. The at least one touch sensor substantially simultaneously detects a force and a position of at least one finger of the hand. The placeable cooktop utensil includes an output unit connected in signal communication with the controller. The output unit and/or the transmitting unit is controllable as a function of an output signal.

### CROSS-REFERENCE TO PRIOR APPLICATIONS

This application is a U.S. National Phase application under 35 U.S.C. § 371 of International Application No. PCT/EP2022/081305, filed on Nov. 9, 2022, and claims benefit to German Patent Application No. DE 10 2021 131 336.8, filed on Nov. 30, 2021. The International Application was published in German on Jun. 8, 2023 as WO/2023/099140 A1 under PCT Article 21 (2).

### FIELD

The invention relates to a placeable cooktop utensil having a handle.

### BACKGROUND

Various embodiments of such placeable cooktop utensils and methods for operating the same are known from the prior art. The known placeable utensils include, for example, at least one handle having a gripping portion with at least one gripping region that is integrated in the handle, allowing a user to grip the placeable utensil with a hand; a controller; and a transmitting unit connected in signal communication with the controller for transmitting signals from the placeable utensil to the cooktop, the gripping region having at least one touch sensor that is connected in signal communication with the controller for detecting when the handle is gripped. In this regard, see, for example, DE 10 2019 126 830 A1.

Further, DE 10 2018 110 125 A1 describes a utensil for preparing food and/or liquid on a cooktop or in a cooking chamber, the utensil having at least one scale for weighing food and/or liquid filled in the preparation utensil, and further having at least one handle for handling the preparation utensil. In order to improve the functionality of the preparation utensil, the at least one scale is disposed in the at least one handle of the preparation utensil.

### SUMMARY

In an embodiment, the present invention provides a placeable cooktop utensil, comprising: at least one handle having a gripping portion with at least one gripping region that is integrated in the handle so as to allow a user to grip the placeable utensil with a hand; a controller; and a transmitting unit connected in signal communication with the controller so as to transmit signals from the placeable utensil to the cooktop, wherein the at least one gripping region has at least one touch sensor connected in signal communication with the controller so as to detect when the at least one handle is gripped, wherein the at least one touch sensor is configured to substantially simultaneously detect a force and a position of at least one finger of the hand, wherein the placeable cooktop utensil comprises an output unit connected in signal communication with the controller, and wherein the output unit and/or the transmitting unit is controllable as a function of an output signal of the at least one touch sensor to control the cooktop.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a first exemplary embodiment of the inventive placeable cooktop utensil for performing the method of the invention;

FIG. 2 is a partial side view of the first exemplary embodiment; and

FIG. 3 is a perspective view of a second exemplary embodiment of the inventive placeable cooktop utensil for performing the method of the invention.

### DETAILED DESCRIPTION

In an embodiment, the present invention improves a placeable cooktop utensil and a method for operating a placeable utensil that can be placed on a cooktop.

In an embodiment, the present invention provides a placeable cooktop utensil which is characterized in that the touch sensor is designed to substantially simultaneously detect a force and a position of at least one finger of the hand: an output unit of the placeable utensil, which output unit is connected in signal communication with the controller, and/or the transmitting unit being controllable as a function of an output signal of the touch sensor to control the cooktop. In an embodiment, the invention provides a method for operating a placeable utensil capable of being placed on a cooktop.

An advantage provided by the invention is that a placeable cooktop utensil and a method for operating a placeable utensil are improved. The inventive design of the placeable utensil for placement on a cooktop and of the method for operating such a placeable utensil enables cost-effective identification of a user using the placeable utensil. In addition, by providing the at least one touch sensor in the gripping portion to detect when the handle is touched by the user in order to manually move the placeable utensil, it is possible to automatically detect a gripping intention of the user of the placeable utensil. Furthermore, the invention makes it possible to estimate a degree of filling of the placeable utensil: i.e., a fill weight of a food filled in the placeable utensil and/or of a liquid filled in the placeable utensil, without much effort. The invention also makes it possible to determine a behavior of the user during use of the placeable utensil, so that, for example, an interaction of the user with the placeable utensil can be determined without additional means. This also makes it possible to significantly improve safety during use of the placeable utensil and/or of the cooktop without reducing the ease of use for the user of the placeable utensil. For example, user profiles for individual users could be stored in the controller of the placeable utensil, so that certain users or user groups, such as users with limited abilities and/or children, can use the placeable utensil and/or the cooktop only within predefined limits. In this context, it is also possible to use the so-called artificial intelligence technology.

The placeable utensil can be freely selected within wide suitable limits in terms of type, function, dimensions, and material. The placeable utensil may, for example, be in the form of a pan or a pot. However, other embodiments, such as kettles, roasters, or the like, are also conceivable. Depending on the specific embodiment of the placeable utensil, it may have one or a plurality of handles, it being possible for the inventive design of the handle to be provided for merely one of the handles or for a plurality thereof. The at least one gripping portion including the gripping region is configured as a touch-sensitive region of the handle by means of the at least one touch sensor. In other embodiments, the at least one gripping region may additionally be configured as a proximity-sensitive region. The at least one gripping region may be disposed on the handle such that it is visible or invisible from the outside. For example, the at least one gripping region may be fully integrated into the handle so that this gripping region is neither visible nor palpable from the outside. The placeable utensil may be designed to be suitable for an inductive cooktop. However, this is not absolutely necessary. The placeable utensil according to the invention may be designed to be suitable for all conceivable types of cooktops.

As a general principle, the further processing of the detection that the handle is touched by the user: i.e., the method for processing the detection that the handle is touched by the user, can be freely selected within wide suitable limits. This applies similarly to the corresponding embodiment of the placeable utensil according to the invention.

An advantageous refinement of the placeable utensil according to the invention provides for the touch sensor to be disposed on the handle or in the handle in a manner that allows the touch sensor to be functionally reliably touched by the at least one finger when the handle is gripped by the hand. This ensures functionally reliable detection of the gripping of the handle, i.e., the gripping by the user.

A further advantageous refinement of the placeable utensil according to the invention provides for the at least one touch sensor to be in the form of at least one first touch sensor and one second touch sensor, the first touch sensor being located on the side of the handle facing the cooktop and the second touch sensor being located on the side of the handle facing away from the cooktop when the placeable utensil is placed on the cooktop. This further simplifies the handling of the placeable utensil without thereby impairing the functional reliability in gripping detection by means of the at least one touch sensor. The ergonomics of use of the placeable utensil according to the invention are further improved accordingly.

Another advantageous refinement of the placeable utensil according to the invention provides for the touch sensor to be designed as a touch-sensitive film. Films can be applied particularly easily to a handle for a placeable utensil. For example, touch-sensitive films can be very easily applied to the handle in a conforming and tight manner, so that the functionality of the touch sensor is not impaired by environmental conditions occurring during cooking.

One aspect is to design the touch sensor or a touch-sensitive region as a glass cover. Preferably, the touch sensor is disposed below the glass cover, and the glass cover forms a portion of the outer surface of the placeable utensil.

A further advantageous refinement of the placeable utensil according to the invention provides for the placeable utensil to have at least one input unit that is connected in signal communication with the controller and has at least one input area integrated in the handle for a user of the placeable utensil to input a user command, the input area being disposed in an input portion positionally different from the gripping portion, and the placeable utensil and/or the cooktop being controllable by means of the user command. Thus, for example, safety during use of the placeable utensil and, in particular, during use of the cooktop is significantly improved without reducing the ease of use for the user of the placeable utensil. The clear spatial separation of the handle into a gripping portion and the at least one input portion effectively counteracts any unintentional control action on the at least one input portion of the at least one input unit when the handle is gripped to manually move the placeable utensil. Thus, in the placeable utensil according to the invention, it is possible to distinguish between a control action on the handle for the purpose of inputting a user command, on the one hand, and a control action on the handle for the purpose of manually moving the placeable utensil, on the other hand.

An advantageous refinement of the aforementioned embodiment of the placeable utensil according to the invention provides that the inputting of the user command can be blocked by the controller based on the touch sensor detecting the gripping. This further enhances the protection against improper handling of the placeable utensil. The touch sensor may be in the form of a capacitive sensor, for example.

Another advantageous refinement of the placeable utensil according to the invention provides that the controller of the placeable utensil and/or a cooktop controller are/is transferable from a standby mode to a ready mode or an operating mode based on the touch sensor detecting that the handle is touched, the controller and/or the cooktop controller being designed in the standby mode essentially merely to transfer to the ready mode or the operating mode: in the ready mode, to associate the placeable utensil with a cooking zone of the cooktop; and in the operating mode, to operate the placeable utensil and/or the cooktop in the full functionality thereof. This enables energy-efficient operation of the placeable utensil and/or of the cooktop. In addition, the ease of use is thereby further enhanced, while at the same time ensuring safety during use of the placeable utensil and of the cooktop.

Another advantageous refinement of the placeable utensil according to the invention provides that the touch sensor is also configured as a further input area for inputting a further user command for controlling the placeable utensil and/or the cooktop, preferably, that the placeable utensil and/or the cooktop can be switched on by the controller based on detecting that the handle is touched. Thus, the at least one touch sensor can also used to allow the user to intuitively input a further user command. This enhances the functionality of the at least one touch sensor. This inputting of a further user command may take place in addition or alternatively to the inputting of a user command via the at least one input area.

As already explained above, the method according to the invention can be freely selected within wide suitable limits.

In accordance with the above explanations regarding the placeable utensil according to the invention, an advantageous refinement of the inventive method provides that, by means of the at least one touch sensor, a fill weight of a food and/or liquid filled in the placeable utensil is detected, and/or an individual handling the placeable utensil and/or a member of a group of people who is handling the placeable utensil are/is detected, and/or the at least one touch sensor is also used as a further input area for inputting a further user command for controlling the placeable utensil and/or the cooktop, preferably, that a handling interaction of the user with the placeable utensil is detected and/or a cooktop action is started and/or selected and/or terminated.

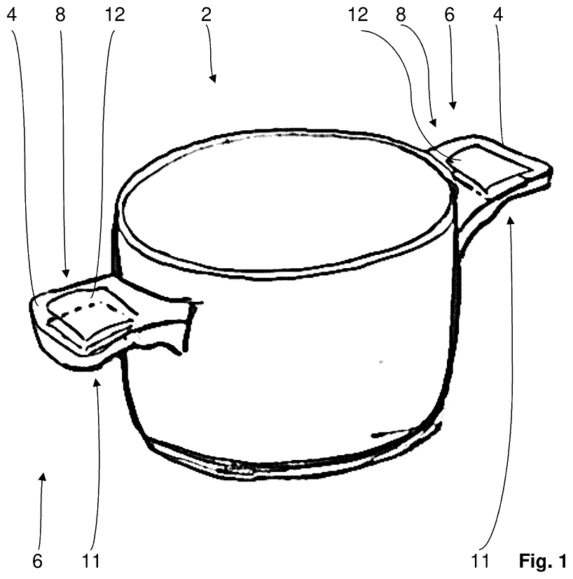

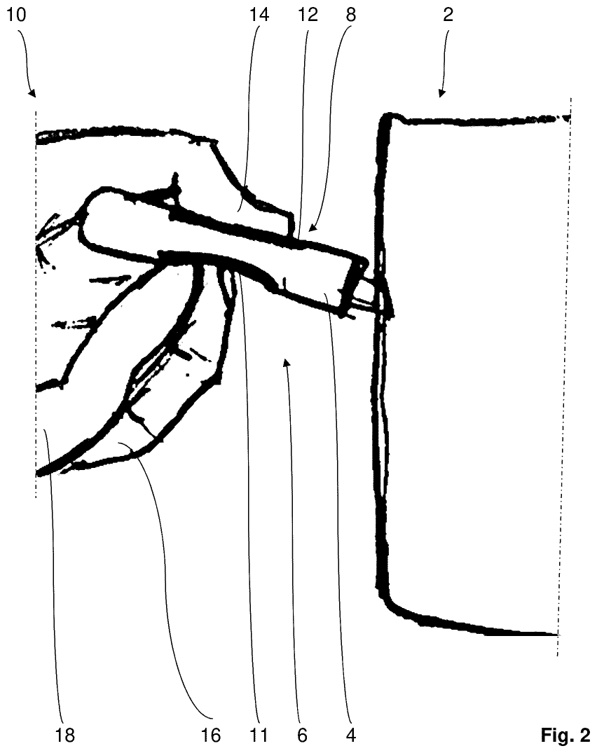

In FIGS. 1 and 2, a first exemplary embodiment of the inventive placeable cooktop utensil for performing the method of the invention is illustrated in purely schematic form.

Placeable utensil 2 is configured here as a cooking pot for placement on a cooktop and includes two handles 4, each having a gripping portion 6 with a gripping region 8 that is integrated in handle 4, allowing a user to grip placeable utensil 2 with a hand 10; a controller; and a transmitting unit connected in signal communication with the controller for transmitting signals from placeable utensil 2 to the cooktop, the gripping region 8 having two touch sensors that are connected in signal communication with the controller for detecting when handle 4 is gripped, namely, a first touch sensor 11, which faces the cooktop when placeable utensil 2 is placed on the cooktop, and a second touch sensor 12, which faces away from the cooktop when placeable utensil 2 is placed on the cooktop.

According to the invention, the first and second touch sensors 11, 12 are each designed to substantially simultaneously detect a force and a position of at least one finger, e.g., thumb 14, index finger 16, and middle finger 18, of the left hand 10, the transmitting unit connected in signal communication with the controller being controllable as a function of output signals of touch sensors 11, 12 to control the cooktop. In this regard, see FIG. 2, which partially shows the handle 4 depicted on the left in the plane of FIG. 1 and the left hand 10 of the user. Alternatively or additionally, it is conceivable that in other embodiments of the invention, an output unit of the placeable utensil may be controllable, by means of the output signals of at least one touch sensor, to output audible and/or visual information to the user of the placeable utensil, similarly to the aforementioned transmitting unit of the present exemplary embodiment.

As can be seen from FIGS. 1 and 2, touch sensors 11, 12 are integrated in the respective handle 4 in such a way that the respective touch sensor 11, 12 can be functionally reliably touched by the at least one finger 14, 16, 18 when handle 4 is gripped by hand 10. In the present exemplary embodiment, the two handles 4 are configured identically to each other, so that explanations given with respect to the handle 4 depicted on the left in the plane of FIG. 1 also apply to the handle 4 depicted on the right in the plane of FIG. 1. To facilitate the integration of touch sensors 11, 12, they are each designed as a touch-sensitive film.

The placeable utensil 2 according to the present exemplary embodiment is further is configured and adapted such that the controller and a cooktop controller of the cooktop are transferable from a standby mode to a ready mode or an operating mode based on the touch sensors 11, 12 detecting that the respective handle 4 is touched, the controller and/or the cooktop controller being designed in the standby mode essentially merely to transfer to the ready mode or the operating mode: in the ready mode, to associate placeable utensil 2 with a cooking zone of the cooktop; and in the operating mode, to operate placeable utensil 2 and the cooktop in the full functionality thereof.

Accordingly, the respective touch sensor 11, 12 of each of the handles 4 is here also configured as a further input area for inputting a further user command for controlling the cooktop, namely, in such a way that the placeable utensil and the cooktop can be switched on by the controller based on detecting that the respective handle 4 is touched. The use of the expressions “a further input area” and “a further user command” serves merely for purposes of distinction from an alternative or additional input area that may be provided for inputting user commands, which will be explained in more detail below.

In the following, the operation of the inventive placeable utensil and the inventive method according to the present first exemplary embodiment will be described in more detail with reference to FIGS. 1 and 2.

To allow for a most energy-efficient operation of placeable utensil 2 and of the cooktop, it is provided, in accordance with the above explanations, that the controller of placeable utensil 2 and the cooktop controller are transferred from the respective standby mode to a ready mode or an operating mode based on the touch sensors 11, 12 detecting that the respective handle 4 is touched. In the standby mode, the controller and/or the cooktop controller are essentially merely transferred to the ready mode or the operating mode; in the ready mode, they associate placeable utensil 2 with one of the cooking zones of the cooktop; and in the operating mode, they operate placeable utensil 2 and the cooktop in the full functionality thereof. Accordingly, the controller of the placeable utensil ′2 and the cooktop controller are transferred from the respective standby mode to the respective ready mode or the respective operating mode if the corresponding touch sensors 11, 12 have detected that one of the handles 4 is touched. For example, placeable utensil 2 and the cooktop are switched on by the controller based on detecting that one of the two handles 4 is touched.

In addition to detecting when one of the handles 4 is touched by the user, touch sensors 11, 12 may here also be used for at least one further function, namely, for inputting a further user command. For example, it is conceivable that at least one of the at least one touch sensor 11, 12 is designed to detect a rotation of the human hand 10 relative to the respective handle 4, the further user command being input by the user based on detecting the rotation. In the present exemplary embodiment, in order to select a power level for the aforementioned cooking zone of the cooktop on which placeable utensil 2 has been placed, the user could, for example, be able to raise or lower the power level for this cooking zone by rotating his/her hand 10 about an axis of handle 4, i.e., by moving the fingers 14, 16, 18 relative to the corresponding touch sensor 11, 12, the power level being raised or lowered depending on the direction of rotation.

In addition, it may be provided that a power setting of the cooktop is automatically reduced by the controller so as to effectively protect, for example, sensitive components of the cooktop which could be damaged or impaired in their function due to a mechanical stress resulting from a user manually moving placeable utensil 2.

As already explained above, a fill weight of a food and/or liquid filled in the placeable utensil, for example, is detected by means of touch sensors 11, 12. The food and the liquid are not shown in FIGS. 1 and 2. Touch sensors 11, 12 also detect an individual who is handling placeable utensil 2, i.e., the particular user of placeable utensil 2. It is also conceivable, however, that a member of a group of people, for example, a child or an adult with limited abilities who is using placeable utensil 2 may be detected by touch sensors 11, 12. The special design of touch sensors 11, 12 thus allows the respective gripping region 8 to be also used as a further input area for inputting a further user command for controlling placeable utensil 2 and/or the cooktop, namely, in such a way that a handling interaction of the user with placeable utensil 2 is detected and/or a cooktop action is started and/or selected and/or terminated.

In accordance with the above explanations regarding the present first exemplary embodiment, the placeable utensil 2 according to the first exemplary embodiment is very versatile. Based on the forces measured by touch sensors 11, 12, it is thus possible to automatically detect the degree to which placeable utensil 2 is filled with a food and/or a liquid. Accordingly, this information may be used to provide cooking assistance using a cooking assistance system and adapt the cooking assistance to individual requirements. Furthermore, critical situations during cooking or frying can be recognized or prevented early enough. In addition, it is possible to implement user actions, i.e., interactions of the user with placeable utensil 2, to save energy and/or to increase safety during use of placeable utensil 2 and/or of the cooktop on which placeable utensil 2 is placed.

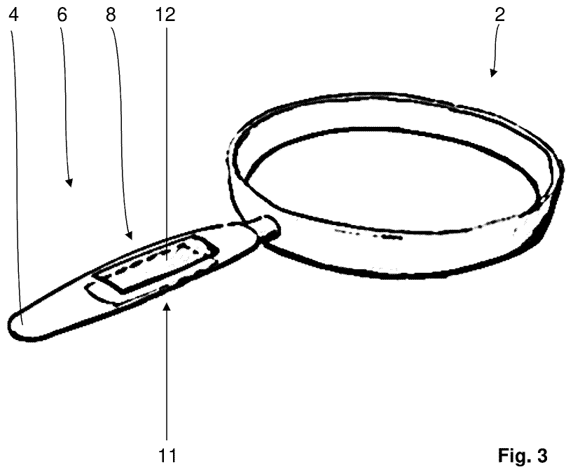

FIG. 3 shows a second exemplary embodiment of the placeable utensil according to the invention.

The placeable utensil 2 of the second exemplary embodiment is designed as a pan and, unlike the first exemplary embodiment, has only one handle 4, namely a handlebar. In other respects, the second exemplary embodiment is similar to the first exemplary embodiment according to FIGS. 1 and 2, and, therefore, reference is also made to the above explanations regarding the first exemplary embodiment.

The inventive design of the placeable utensil 2 for placement on the cooktop and of the method for operating placeable utensil 2 enables cost-effective identification of a user using placeable utensil 2. In addition, by providing the at least one touch sensor 11, 12 in gripping portion 6 to detect when handle 4 is touched by the user in order to manually move placeable utensil 2, it is possible to automatically detect a gripping intention of the user of placeable utensil 2. Furthermore, placeable utensil 2 and the corresponding method for operating the same make it possible to estimate a degree of filling of placeable utensil 2, i.e., a fill weight of a food filled in placeable utensil 2 and/or of a liquid filled in placeable utensil 2, without much effort. Placeable utensil 2 and the corresponding method also make it possible to determine a behavior of the user during use of placeable utensil 2, so that, for example, an interaction of the user with placeable utensil 2 can be determined without additional means. This also makes it possible to significantly improve safety during use of placeable utensil 2 and of the cooktop without reducing the ease of use for the user of placeable utensil 2. For example, user profiles for individual users could be stored in the controller of placeable utensil 2, so that certain users or user groups, such as users with limited abilities and/or children, can use placeable utensil 2 and/or the cooktop only within predefined limits. In this context, it is possible to use, for example, the so-called artificial intelligence technology.

However, the placeable utensil according to the invention and the method according to the invention are not limited to the exemplary embodiments described above.

The placeable utensil may also be in the form of a kettle, roaster, or the like. Depending on the specific embodiment of the placeable utensil, it may have one or a plurality of handles, it being possible for the inventive design of the handle to be provided for merely one of the handles or for a plurality thereof. The placeable utensil may be designed to be suitable for an inductive cooktop. However, this is not absolutely necessary. The placeable utensil according to the invention may be designed to be suitable for all conceivable types of cooktops.

The at least one touch sensor can be freely selected within wide suitable limits in terms of type, function, dimensions, material, number, and arrangement. Thus, the above explanations should be taken to be merely illustrative and not limiting. Depending on the particular application, one skilled in the art will appropriately select the at least one touch sensor and combine different sensor technologies, for example.

In addition to the transmitting unit, the placeable utensil according to the invention may also have a receiving unit for the purpose of transmitting signals from the cooktop to the placeable utensil. It is also conceivable that the transmitting unit of the placeable utensil according to the invention may be in the form of a combined transmitting/receiving unit.

In contrast to the two exemplary embodiments described, other embodiments of the invention may provide that the placeable utensil has, in addition or as an alternative to the aforementioned further input area, at least one input unit that is connected in signal communication with the controller and has at least one input area integrated in the handle for a user of the placeable utensil to input a user command, the input area being disposed in an input portion positionally different from the gripping portion, and the placeable utensil and/or the cooktop being controllable by means of the user command. Thus, for example, safety during use of the placeable utensil and, in particular, during use of the cooktop is significantly improved without reducing the ease of use for the user of the placeable utensil. The clear spatial separation of the handle into a gripping portion and the at least one input portion effectively counteracts any unintentional control action on the at least one input portion of the at least one input unit when the handle is gripped to manually move the placeable utensil. Thus, in the placeable utensil according to the invention, it is possible to distinguish between a control action on the handle for the purpose of inputting a user command, on the one hand, and a control action on the handle for the purpose of manually moving the placeable utensil, on the other hand. The at least one input area may be disposed on the handle such that it is visible or invisible from the outside. For example, the at least one input area may be fully integrated into the handle so that this input area is neither visible nor palpable from the outside.

An advantageous refinement of the aforementioned embodiment of the placeable utensil according to the invention provides that the inputting of the user command can be blocked by the controller based on the touch sensor detecting the gripping. This further enhances the protection against improper handling of the placeable utensil. The touch sensor may be in the form of a capacitive sensor, for example.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A placeable cooktop utensil, comprising:
at least one handle having a gripping portion with at least one gripping region that is integrated in the handle, allowing so as to allow a user to grip the placeable utensil with a hand;
a controller; and
a transmitting unit connected in signal communication with the controller so as to transmit signals from the placeable utensil to the cooktop,
wherein the at least one gripping region has at least one touch sensor connected in signal communication with the controller so as to detect when the at least one handle is gripped,
wherein the at least one touch sensor is designed configured to substantially simultaneously detect a force and a position of at least one finger of the hand,
wherein the placeable cooktop utensil comprises an output unit connected in signal communication with the controller, and
wherein the output unit and/or the transmitting unit is controllable as a function of an output signal of the at least one touch sensor to control the cooktop.

2. The placeable utensil of claim 1,
wherein the at least one touch sensor is disposed on the at least one handle or integrated in the at least one handle in such that the at least one touch sensor is functionally reliably touchable by the at least one finger when the at least one handle is gripped by the hand.

3. The placeable utensil of claim 1,
wherein the at least one touch sensor comprises at least one first touch sensor and one second touch sensor, the first touch sensor being located on a side of the at least one handle facing the cooktop and the second touch sensor being located on a side of the at least one handle facing away from the cooktop when the placeable utensil is placed on the cooktop.

4. The placeable utensil of claim 1,
wherein the at least one touch sensor comprises a touch-sensitive film.

5. The placeable utensil of claim 1,
wherein the placeable utensil has at least one input unit connected in signal communication with the controller and has at least one input area integrated in the at least one handle for the user to input a user command, the at least one input area being disposed in an input portion positionally different from the at least one gripping portion, and
wherein the placeable utensil and/or the cooktop is controllable by the user command.

6. The placeable utensil of claim 5,
wherein an inputting of the user command is blockable by the controller based on the at least one touch sensor detecting the gripping.

7. The placeable utensil of claim 1,
wherein the controller of the placeable utensil and/or a cooktop controller are/is transferable from a standby mode to a ready mode or an operating mode based on the at least one touch sensor detecting that the at least one handle is touched,
wherein, in the standby mode, the controller and/or the cooktop controller are/is configured to transfer to the ready mode or the operating mode,
wherein, in the ready mode, the controller and/or the cooktop controller are/is configured to associate the placeable utensil with a cooking zone of the cooktop, and
wherein, in the operating mode, the controller and/or the cooktop controller are/is configured to operate the placeable utensil and/or the cooktop in a full functionality thereof.

8. The placeable utensil of claim 5,
wherein the at least one touch sensor comprises a further input area for inputting a further user command for controlling the placeable utensil and/or the cooktop.

9. A method for operating the placeable utensil of claim 1, comprising:
detecting, substantially simultaneously by the at least one touch sensor, the force and the position of the at least one finger of the hand; and
controlling the output unit and/or the transmitting unit as a function of the output signal of the at least one touch sensor to control the cooktop.

10. The method of claim 9, further comprising:
detecting, by the at least one touch sensor, a fill weight of a food and/or liquid filled in the placeable utensil, and/or an individual handling the placeable utensil, and/or a member of a group of people who is handling the placeable utensil, and/or
wherein the at least one touch sensor comprises a further input area for inputting a further user command for controlling the placeable utensil and/or the cooktop.

11. The placeable utensil of claim 8, wherein the placeable utensil and/or the cooktop is switchable on by the controller based on detecting that the at least one handle is touched.

12. The method of claim 10, wherein a handling interaction of the user with the placeable utensil is detected and/or a cooktop action is started and/or selected and/or terminated.
